(19) United States
(12) Patent Application Publication
(10) Pub. No.: US 2021/0211242 A1
(43) Pub. Date: Jul. 8, 2021

(54) MULTI-LEVEL ACK FOR AUTOMATIC REPETITIONS

(71) Applicant: Telefonaktiebolaget LM Ericsson (publ), Stockholm (SE)

(72) Inventor: Niklas Andgart, Sodra Sandby (SE)

(21) Appl. No.: 17/049,672

(22) PCT Filed: May 8, 2019
(86) PCT No.: PCT/EP2019/061864

§ 371 Date: Oct. 22, 2020

Related U.S. Application Data
(60) Provisional application No. 62/669,335, filed on May 9, 2018.

(51) Int. Cl. H04L 1/18; H04L 1/16

(52) U.S. Cl. CPC H04L 1/1825; H04L 1/1671; H04L 1/1864

(57) ABSTRACT

The present disclosure relates to methods of transmitting and receiving transmission feedback. More particularly the disclosure pertains to transmitting and receiving messages acknowledging reception and successful decoding of a transport block in a radio network node. The disclosure also relates to a wireless device providing transmission feedback and to a radio network node receiving the transmission feedback. A radio network node transmits using a set of transmission properties, a first sequence of two or more transport blocks to a receiving wireless device, wherein the transmitting is performed without waiting for acknowledgement or non-acknowledgement (ACK/NACK) feedback in-between transport block transmissions, and wherein each of the transport blocks in the first sequence relates to a same packet. The radio network node receives, from the receiving wireless device, the ACK/NACK feedback, indicating reception and decoding outcome of the transport block sequence in the receiving wireless device, wherein the ACK/NACK feedback defines a decoding margin of the decoding. The disclosure also proposes a corresponding wireless device and corresponding methods as well as a corresponding computer program.

### TECHNICAL FIELD

The present disclosure relates to methods of transmitting and receiving transmission feedback to a radio network node. More particularly the disclosure pertains to transmitting and receiving messages acknowledging reception and successful decoding of a transport block in a wireless device. The disclosure also relates to a wireless device providing transmission feedback and to a radio network node receiving the transmission feedback.

### BACKGROUND

The 3rd Generation Partnership Project, 3GPP, is responsible for the standardization of the Universal Mobile Telecommunication System (UMTS) and Long Term Evolution, LTE. The 3GPP work on LTE is also referred to as Evolved Universal Terrestrial Radio Access Network (E-UTRAN). LTE is a technology for realizing high-speed packet-based communication that can reach high data rates both in the downlink and in the uplink, and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex (FDD) and Time Division Duplex (TDD) modes.

Hybrid Automatic Repeat request (HARQ) is an integral part of the 3G and 4G standards that allows reliable communication between a wireless device and a network node by means of incremental redundancy. The transport block to be transmitted is subjected to forward error correction encoding by which redundancy is introduced. The number of bits increases due to the introduced redundancy, but not all bits are sent at the same time. The resulting bits are segmented into several so called redundancy versions, where each such redundancy version further is punctured before being sent in order to fit it within the given allocation (one or more resource block pairs). How much is punctured depends on how many bits (information plus redundant bits) can be carried in the allocation, which further depends on the allocation bandwidth, the type of modulation (e.g. QPSK, 16QAM, 256QAM) in use, and the presence of broadcasted signals and channels in the allocated bandwidth. The ratio between the information bits and information bits plus redundant bits in a transport block is referred to as code rate. The combination of code rate and modulation type is referred to as Modulation and Coding Scheme.

In case the maximum number of retransmissions is reached without the receiving entity being able to decode the transport block, it will be detected by higher layers e.g. Radio Link Control, RLC, generally within 50-100 ms that a Protocol Data Unit (PDU) is missing and a retransmission is requested for all transport blocks that comprise the RLC PDU, even those that may have been successfully communicated. This is referred to as Automatic Repeat request (ARQ) and has considerably larger latency than HARQ retransmissions.

HARQ retransmissions are an efficient way to improve reliability, while at the same time being spectrum efficient, as retransmissions occur only when needed. A drawback is that each new HARQ retransmission increases the latency, as first the receiving node needs to try to decode, then send a NACK, and then the transmitting node should schedule a retransmission. A way to achieve high reliability, without adding so much to total latency, is to introduce automatic repetitions, where the retransmissions are sent without waiting for NACK feedback. The repetition can then be sent already in the following TTI, to keep the latency low. The number of repetitions can either be configured by higher layers, or it can be dynamic, where number of repetitions is specified in the DCI. With automatic repetitions, a sequence of transport blocks is sent, all representing the same data packet. The individual transport blocks can be sent with same or different redundancy versions.

A TTI, Transmission time interval, here represents a period in time where one transmission is sent. It can be a subframe, as in LTE prior to release 15, or slots or subslots, as in LTE with shortened TTI. It can also be slots or minislots in NR or 5G.

In an LTE network, a wireless device (in LTE referred to as a User Equipment, UE) carries out measurements to provide indications to the base station (in LTE eNodeB) on the perceived radio propagation conditions in what is called Channel Quality Indicator (CQI) reporting. Based on the reporting the base station can decide roughly which Modulation and Coding Scheme (MCS) to use for communication with the UE. One example of mapping between CQI and MCS is shown in Table 1 below, which is retrieved from 3GPP TS 36.213 V10.12.0 section 7.2.3. In low channel quality (low CQI index) more forward error correction encoding is needed for successful decoding of the information bits, and vice versa in high channel quality i.e. high CQI index. Hence at high CQI the throughput of information bits can be made higher than at low CQI.

TABLE 1
4-bit CQI table from 3GPP

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In order to get a good system throughout the base station, in LTE referred to as an eNB, carries out link adaptation by which it matches each UE's reported channel quality to an MCS that provides the right balance between system throughput and throughput for the individual user.

The MCS is indicated to the UE in the Downlink Control Information (DCI) provided over Physical Data Control Channel, PDCCH in LTE. This is shown in Table 2 which is the retrieved from 3GPP TS 36.213 V10.12.0 section 7.1.7.1.

In addition to CQI reporting, a base station typically has an outer loop that, based on ACK/NACK reports, tunes in the MCS value to a suitable value giving a BLER (ratio between NACKs and total number of received or expected ACK/NACKs) of e.g. 10%. Besides catering for flexibility in which target BLER is used (e.g. 1%, 10%, 30%), it also solves the problem that each UE model or even UEs of the same model may have an individual bias in the reported CQI. The base station thus maintains a UE-specific CQI offset which it tunes to give the desired BLER target.

TABLE 2
Modulation and TBS index table for PDSCH

| MCS Index | Modulation Order | TBS Index |
|---|---|---|
| I_{MCS} | Qₘ | I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 2 | reserved |
| 30 | 4 | |
| 31 | 6 | |

Existing power control loops on the base station side for determining the UE-specific MCS are largely based on maintaining a particular BLER ratio and identifying UE-specific bias in the CQI reporting. Once the CQI bias has been identified the base station can more accurately select MCS based on the CQI reported by the UE. During identification of the CQI bias the base station will decrease or increase the MCS until the BLER target is met over some interval of time.

The expansion of machine-type communication (MTC) toward industrial applications is seen as one of the key features in future communication systems. The requirements on connectivity are very diverse and largely depend on the use case of an industrial application to be operated. Therefore, different Critical-MTC (C-MTC) (i.e., ultra-reliable MTC) solutions will be needed. Besides the end-to-end latency, the Critical-MTC concept should address the design trade-offs regarding transmission reliability, mobility, energy-efficiency, system capacity and deployment, and provide solutions for how to design a wireless network in a resource and energy efficient way while enabling ultra-reliable communication.

For scheduling of UEs that are to fulfill extreme requirements on BLER, e.g. down to 10⁻⁹, while at the same time fulfilling extreme requirements on latency, i.e. being able to send and receive new information every sub frame, block errors have to be avoided as far as possible.

With existing implementation it may however be problematic to adjust to e.g. a proper MCS without introducing block errors occasionally and as a result the base station (or network node) is forced to be very conservative in the MCS selection. Being conservative implies using a lower/less aggressive MCS than called for, resulting in more resources being used for the particular UE than necessary, with reduced system throughput as a result.

### SUMMARY

An object of the present disclosure is to provide a method which seeks to mitigate, alleviate, or eliminate one or more of the above-identified deficiencies in the art and disadvantages singly or in any combination.

In some embodiments, this is obtained by a method, performed in a radio network node (20), of receiving transmission feedback, the method comprising transmitting, using a set of transmission properties, a first sequence of two or more transport blocks to a receiving wireless device, wherein the transmitting is performed without waiting for acknowledgement or non-acknowledgement (ACK/NACK) feedback in-between transport block transmissions, and wherein each of the transport blocks in the first sequence relates to a same packet. The method in these embodiments also comprises receiving, from the receiving wireless device, the ACK/NACK feedback, indicating reception and decoding outcome of the transport block sequence in the receiving wireless device, wherein the ACK/NACK feedback defines a decoding margin of the decoding.

The decoding margin may be utilized in different ways by the base station. For example, the network node can have an outer loop based on margin of decoding instead of on BLER for the category of UEs supporting high reliability and low latency, and may thereby tune in to correct MCS value without losing any packets.

Another example would e.g. be to use the decoding margin or statistics thereof, to identify areas, in e.g. a factory, where the coverage for UEs supporting high reliability and low latency is not sufficient and thus needs to be improved.

According to some aspects, the method further comprises reconfiguring the transmission properties to be used for transmissions of one or more further transport blocks to the receiving wireless device, based on the decoding margin. Since a less conservative MCS, or fewer repetitions, will be used for the UE, more resources will be available to other UEs and the system throughput will improve.

According to some aspects, the method further comprises calculating an accumulated decoding margin, representing the decoding margin of previous and present transport blocks transmitted, using the set of transmission properties, between the radio network node and the wireless device, wherein the reconfiguring is based on the accumulated decoding margin.

According to some aspects, the decoding margin comprises an indication of a portion of the number of repeated transmissions that was needed in order to decode the packet transmitted by the transport block sequence.

According to some aspects, the receiving implies receiving information defining one of several possible ACK levels, wherein each level corresponds to a decoding margin within a pre-defined range. Hence, a UE or wireless device may decide whether to send “Soft ACK” or “Hard ACK” for a successfully decoded block based on how many transmissions it needed to decode the packet.

Then the base station may, instead of maintaining a target BLER, maintain a target “Soft ACK” Ratio, SAR. Tuning the MCS based on SAR allows the base station to be more aggressive when searching for a proper MCS, as it can do so without introducing block errors.

According to some aspects, the disclosure relates to a radio network node configured for receiving transmission feedback. The radio network node comprises a radio communication interface and processing circuitry. The processing circuitry is configured to transmit, through the radio communication interface using a set of transmission properties, a transport block sequence to a receiving wireless device. The processing circuitry is further configured to receive, through the radio communication interface, from the receiving wireless device, an acknowledgement, ACK, confirming the reception and successful decoding of the transport block sequence in the receiving wireless device. The ACK defines a decoding margin of the decoding. The processing circuitry is further configured to reconfigure the transmission properties to be used for transmissions of one or more further transport block sequences to the receiving wireless device, based on the decoding margin.

According to some other aspects, the disclosure relates to a radio network node configured for receiving transmission feedback, the radio network node comprising a radio communication interface and processing circuitry, wherein the processing circuitry is configured to transmit, through the radio communication interface using a set of transmission properties, a first sequence of two or more transport blocks to a receiving wireless device, wherein the transmission is performed without waiting for ACK/NACK feedback in-between transport block transmissions, and wherein each of the transport blocks in the first sequence relates to a same packet. The processing circuitry is further configured to receive, through the radio communication interface, from the receiving wireless device, the ACK/NACK feedback, indicating reception and decoding outcome of the first transport block sequence in the receiving wireless device, wherein the ACK/NACK feedback defines a decoding margin of the decoding.

According to some aspects, the disclosure relates to a method, performed in a wireless device, of providing transmission feedback. The method comprises receiving a sequence of two or more transport blocks from the radio network node, decoding one or more of the transport blocks, transmitting, to the radio network node, an acknowledgement, ACK, of the reception and successful decoding of a transport block sequence, wherein the ACK defines a decoding decoding margin.

According to some other aspects, the disclosure relates to a method, performed in a wireless device, of providing transmission feedback. In such embodiments, the method comprises receiving a sequence of transport blocks from the radio network node, wherein each of the transport blocks in the sequence relates to a same packet; decoding one or more of the transport blocks; and transmitting, to the radio network node, ACK/NACK feedback indicating reception and decoding outcome of the transport block sequence, wherein the ACK/NACK feedback defines a decoding margin, and wherein the decoding margin indicates how many of the transport blocks in the sequence were needed to successfully decode the packet.

The exchange of acknowledgements including a decoding margin enables the network node to be less conservative when selecting MCS and number of repetitions for the device, thereby allowing more resources to be used for other UEs. As a consequence the system throughput can be improved while at the same time offering highly reliable communication with the device.

According to some aspects, the ACK defines one of several possible ACK levels, wherein each ACK level corresponds to a decoding margin within a pre-defined range.

According to some aspects, the disclosure relates to a wireless device configured for providing transmission feedback. The wireless device comprises a radio communication interface and a processing circuitry. The processing circuitry is configured to receive, through the radio communication interface, a transport block from the radio network node and to decode the transport block. The wireless device is further configured to transmit, through the radio communication interface, to the radio network node, an acknowledgement, ACK, confirming the reception and successful decoding of the sequence of transport blocks, wherein the ACK defines a decoding margin.

According to some other aspects, the disclosure relates to a wireless device configured for providing transmission feedback. The wireless device comprises a radio communication interface and processing circuitry. The processing circuitry is configured to receive, through the radio communication interface, a sequence of transport blocks from the radio network node, wherein each of the transport blocks in the sequence relates to a same packet. The wireless device is further configured to decode one or more of the transport blocks; and to transmit, through the radio communication interface, to the radio network node, ACK/NACK feedback indicating reception and decoding outcome of the transport block sequence, wherein the ACK/NACK feedback defines a decoding margin, and wherein the decoding margin indicates how many of the transport blocks in the sequence were needed to successfully decode the packet.

The disclosure also relates to a computer program comprising computer program code which, when executed in a programmable controller of a radio network node, causes the radio network node to execute the methods described above and below.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1a is illustrating a radio network node and a wireless device;

FIG. 1b is a sketch of LTE physical layer downlink and uplink processing;

FIG. 2 is a flowchart illustrating embodiments of method steps in a radio network node;

FIG. 3 is a flowchart illustrating embodiments of method steps in a wireless device;

FIGS. 4a and 4b are illustrating the signaling between a radio network node and a wireless device in accordance with the proposed technique;

FIG. 5 is an example node configuration of a radio network node, according to some of the example embodiments.

FIG. 6 is an example node configuration of a wireless device, according to some of the example embodiments.

FIG. 7 is a flowchart showing example processing steps of the disclosure on base station side in one example embodiment.

FIG. 8 is a flowchart showing example processing steps in a wireless device in one example embodiment.

FIGS. 9a and 9b are flowcharts depicting an example of respective network node and wireless device node operations when the decoding margin is transmitted as a separate indicator indicating after which transmitted block the wireless device managed to decode the packet;

FIGS. 10a and 10b illustrates different timings of the ACK/NAK transmission.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein; rather, these embodiments are provided by way of example to convey the scope of the subject matter to those skilled in the art. Additional information may also be found in the document provided in the Appendix. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Incremental redundancy allows a wireless device to attempt to receive and decode a first redundancy version of the transport block, and in case it fails, it receives a second redundancy version of the transport block, which it combines with the first one in so called soft combining and tries to decode. (Re)-transmissions of the same transport block occur at minimum 8 ms distance unless features such as automatic repetitions or Transmission time interval, TTI, bundling are used, by which several redundancy versions are transmitted in subsequent sub frames without waiting for feedback on whether a previous redundancy version was successfully decoded.

The receiving entity, wireless device or base station, provides feedback to the transmitting entity on whether it decoded the transport block successfully, ACK, or whether it failed, NACK.

The transmitting entity then can decide on whether to transmit another redundancy version for the same block, or send a redundancy version for a next transport block.

There is prior art revealing the usage of multiple NACK levels (i.e. when a transmission is not received successfully) for different purposes and different content e.g. quality level, although sometimes referred to as partial ACK. For example European patent application EP2663007A1 discloses a method for transmission of positive acknowledgement messages and negative acknowledgement messages from a first network device to a second network device for data packets received at the first network device, wherein each of said negative acknowledgement messages indicates one quality level of at least two different quality levels dependent on a quality of a data packet received at the first network device, and a differentiation between positive acknowledgement messages and negative acknowledgement messages has a stronger error protection than a differentiation between negative acknowledgement messages indicating different quality levels.

For extreme requirements on high reliability in combination with low latency one cannot afford NACK for the control of e.g. the MCS. Therefore, this disclosure proposes the possibility to send multiple ACK levels, i.e. acknowledgements transmitted when a transmission is received successfully. The multiple ACK levels indicate a margin of successful decoding.

Hence, the proposed solution includes ways of sending an ACK report that also carries or otherwise informs about the decoding margin associated with the decoded packet at a wireless device. The existing HARQ implementation typically allows binary reporting (ACK or NACK), or possibly several NACK levels. To better allow tuning of MCS on the base station side without introducing more block errors one may introduce two or more levels of ACK, e.g., “Soft ACK”, and “Hard ACK”, where Soft ACK indicates that the block was decoded by the UE with low margin to exhaustion of physical layer processing resources, and Hard ACK indicates that the block was decoded with a good such margin.

Solutions also exist in which the receiver generates a multi-level ACK in order to report how close to its limit in terms of physical layer capacity, the receiver is operating. It may for instance be how many of the turbo decoder iterations that are remaining when successfully decoding the block, or similar kind of metrics.

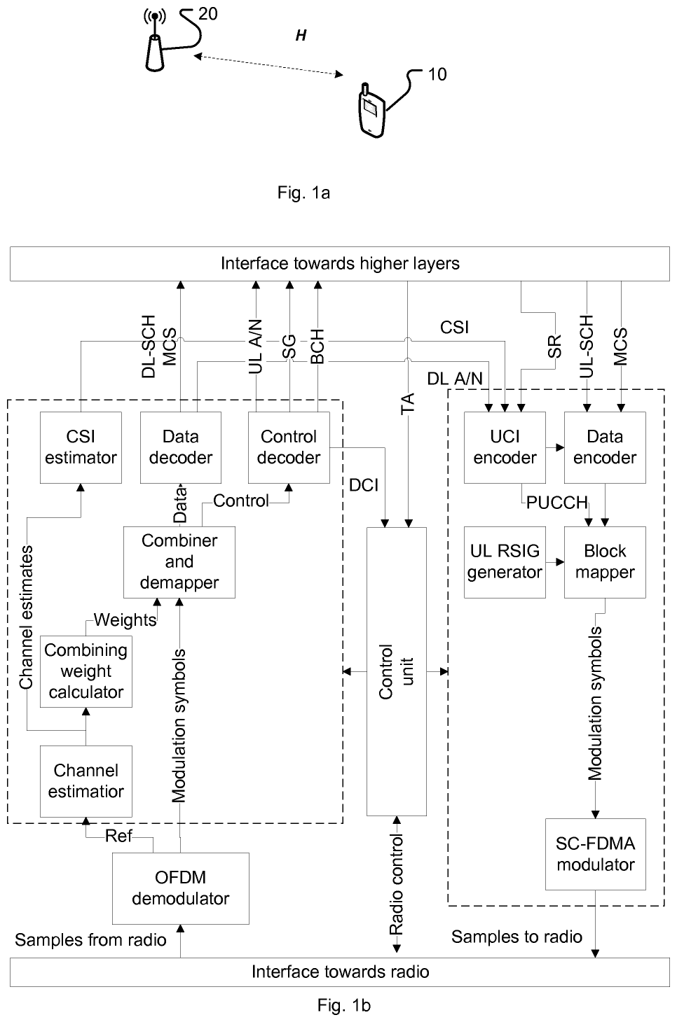

A simplified sketch of the LTE physical layer in a UE is provided in FIG. 1b. Samples are received from the radio, and subjected to an FFT in the OFDM demodulator. The output comprises resource elements carrying e.g. modulation symbols and reference signals. The reference signals are used by the Channel estimator for estimating the radio channel, and from the channel estimates and information on transmission mode and allocated bandwidth the optimum combining weights are derived by the Combining weight calculator. Some reference signals are also used by the CSI estimator for calculating channel state information (CSI, including CQI) which is fed back to the network node. Received modulation symbols and combining weights are fed to the Combiner and demapper which produces soft bits, which further are input to either of the decoders, depending on channel.

The UE first receives and decodes PDCCH (physical downlink control channel) to find downlink control information (DCI) providing information on allocations on PDSCH (physical downlink shared channel) as well as the transmission mode and modulation and coding scheme (MCS) in use, uplink allocations (scheduling grant; SG), uplink power control commands, etc. However before receiving it the UE decodes the physical control format indicator channel (PCFICH) which tells how large the control region is, i.e., how many of the initial OFDM symbols in the subframe are carrying PDCCH. Also, before the decoding the radio propagation channel needs to be estimated and combining weights be produced.

PDCCH is convolutional encoded and is decoded by the Control decoder. The decoded DCI is fed to the Control unit which is used for configuring the baseband. The Control decoder further outputs feedback from the network node on whether transmissions on the uplink were successfully decoded or not (UL ACK/NACK; UL A/N), and is also used for decoding the master information block (MIB) carried on PBCH (physical broadcast channel).

Once the DCI has been decoded, generally at a point in time about in the middle of the subframe, the PDSCH is next. Remaining reference signals in the subframe are used for improving the channel estimates, combining weights are tailored for the transmission mode in use, and then the received modulation symbols are combined and demapped, resulting in soft bits to be subjected to decoding. Since the whole subframe has to be received before the decoding can start, timing-wise this happens in the following subframe, in a pipelined fashion, while control information is received and decoded.

PDSCH is turbo encoded and it is decoded using the Data decoder which mainly comprises hybrid automatic repeat request (HARQ) functionality with associated soft bit combiner, and a turbo decoder. The turbo decoder iterates the decoding until the received data is successfully decoded (as indicated by a successful cyclic redundancy check; CRC) or until running out of time (iterations). In case of failure to decode it may give up earlier if metrics indicate that not much more information is corrected in subsequent iterations, so called early give-up function (EGF).

Due to the pipelined fashion of processing the turbo decoder has to finish within the duration of one subframe. Feedback on whether data was successfully decoded or not (ACK/NACK; DL A/N) is provided to the network node in subframe n+4, where subframe n is the subframe where the data was received.

The CSI reporting may be either periodic, by which the UE knows beforehand when it is to be reported, but may also be a period by which the UE gets informed in the DCI that a CSI report is to be sent in subframe n+4.

The processing time for the OFDM demodulator, Channel Estimator, Combining weight calculator, Combiner and demapper, and Control decoder is highly dependent on the bandwidth in use, whereas the processing time for the Data decoder mainly depends on the UE category which is dictating the size of the HARQ buffers.

When the UE has received an SG in subframe n, it is to transmit on the physical uplink shared channel (PUSCH) in subframe n+4. Scheduling requests (SR), DL A/N, and CSI constitute the uplink control information (UCI) which is encoded by the UCI encoder. Data to be transmitted is encoded by the Data encoder which carriers out Turbo encoding, and then UCI is inserted. The modulation symbols are fed to the Block mapper, which maps the modulation symbols and uplink reference symbols, produced by UL RSIG generator, to the granted allocation. The resulting sequences of symbols are fed to the SC-FDMA modulator which essentially carries out an IFFT, and the output is sent to the radio.

In case no scheduling grant is received but the UE is to provide UL A/N, CSI and SR, the information is transmitted on the physical uplink control channel (PUCCH) according to a predefined format.

The processing time for UL RSIG generator, Block mapper, and SC-FDMA modulator is highly dependent on the bandwidth in use, whereas the processing time for Data encoder is depending on the UE category.

Further, due to timing advance, TA, and the standard stipulating that cell radius up to 100 km shall be supported, the uplink subframe n may have to be transmitted 0.67 ms before downlink subframe n has been received. Hence the UE will have to be able to do all data- and CSI-related processing of a subframe within roughly 2 ms, to meet the times for DL A/N, acting on aperiodic CSI reporting requests, acting on UL A/N from network node, etc.

It shall be noted that due to cost and power effectiveness a UE is generally designed with just the processing capacity, memory size, etc. needed for the supported features and capabilities, e.g. number of DL and UL carriers, respectively, and supported bandwidth for each of them.

This is reflected e.g. by that the FFTs and IFFTs are designed to meet the deadlines on OFDM symbol basis, but not much quicker.

Hence, this disclosure proposes informing a base station about the constraints of the physical layer of the UE. The base station may then, instead of maintaining a target BLER, maintain a target Soft ACK Ratio, SAR. Tuning the MCS based on SAR allows the base station to be more aggressive when searching for a proper MCS, as it can do so without introducing block errors.

Since less conservative MCS will be used for the UE, more resources will be available to other UEs and the system throughput will improve.

The proposed technique of providing extended transmission feedback will now be described in further detail, using LTE as an example.

It should be noted that although terminology from 3GPP LTE is used herein to explain the example embodiments, this should not be seen as limiting the scope of the example embodiments to only the aforementioned system. Other wireless systems, including 5G, New Radio (NR), Wifi, WCDMA, WiMax, UMB and GSM, and future radio access systems may also benefit from the example embodiments disclosed herein.

FIG. 1a illustrates a communication system comprising a radio network node, in LTE an eNodeB 20, and a wireless device 10, in LTE a UE, where the proposed technique may be implemented. In this example the eNodeB 20 transmits a sequence of transport blocks to the UE 10, one transport block after another, without waiting for an ACK/NACK report from the UE 10 in-between transmissions. Each transport block in the sequence relates to a same packet (e.g., each transport block in the sequence is a retransmission of the packet that can be used by the receiver in soft combinations with earlier-received transport blocks to assist with decoding). The UE acknowledges successful reception and indicates a margin of the successful decoding using an aspect of the proposed technique.

Example Node Operations

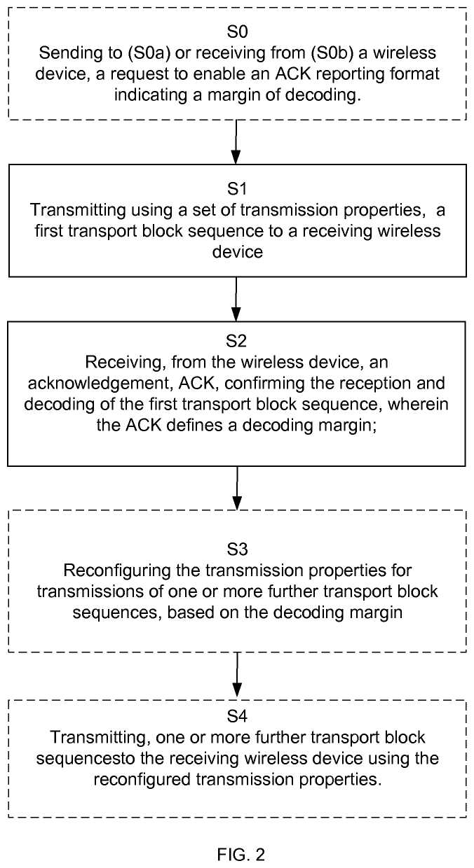

A method performed in the radio network node 20, of receiving transmission feedback in accordance with the proposed technique, will now be described with reference to FIG. 2.

It should be appreciated that FIG. 2 comprises some operations which are illustrated with a solid border and some operations which are illustrated with a dashed border. The operations which are comprised in a solid border are operations which are comprised in a broader example embodiment. The operations which are comprised in a dashed border are example embodiments which may be comprised in, or a part of, or are further operations which may be taken in addition to the operations of the solid border example embodiments. It should be appreciated that the operations need not be performed in order. Furthermore, it should be appreciated that not all of the operations need to be performed. The example operations may be performed in any suitable order and in any combination.

The proposed methods or signaling may be enabled either from the wireless device or from the network node. For example a UE reports a capability regarding multi-level ACK, and may get configured with a Physical Uplink Control Channel, PUCCH, format (not presently in the standard) that allows multi-level ACK reporting. Such information might also be provided explicitly or implicitly in a QoS request, be tied to a particular UE class, or be mandated in the standard from UEs supporting a particular release thereof (e.g. 3GPP EUTRA Rel.13). Typically there is some signaling between the network node and a receiving wireless device resulting in that an ACK reporting format indicating a margin of decoding is enabled.

Hence, according to some aspects, the method is initiated by the network node sending S0a a request to enable an ACK reporting format indicating a margin of decoding, to the receiving wireless device 10. Alternatively, the method is initiated by the network node, receiving S0b a request to enable an ACK reporting format indicating a margin of decoding from the receiving wireless device 10. The initial signaling may be a part of enabling mission critical operation, which is affecting other functions as well.

Now turning back to FIG. 2, the proposed method comprises the step of transmitting S1, using a set of transmission properties, a sequence of transport blocks, all relating to a same packet, to a receiving wireless device 10. The transmitting is performed without waiting for acknowledgement or non-acknowledgement (ACK/NACK) feedback in-between transport block transmissions. A transport block is group of bits or digits that are transmitted as a unit and that may be encoded for error-control purposes. The transport block is e.g. carrying an RLC PDU. Transmission properties here refer to the physical configuration of the receiver. According to some aspects, the transmission properties comprise one or several of the following properties: Number of repeated transport blocks, Modulation and Coding Scheme, Radio Access Technology, Multiple Input Multiple Output transmission modes, Beam forming, Pre-coding Matrix and Transmission Power.

In another aspect, the method further comprises receiving S2, from the receiving wireless device 10, an acknowledgement, ACK, confirming reception and successful decoding of the transport block sequence in the receiving wireless device 10. Historically, the acknowledgement is a signal passed between communicating devices to signify acknowledgement, or receipt of response, as part of a communications protocol. In other words, the receiving wireless device indicated that the packet was successfully decoded and no retransmissions are required. According to the present disclosure, the ACK further defines a decoding margin of the decoding. Or in other words, the ACK comprises information indicative of the decoding margin of the successful decoding.

Information indicative of a decoding margin is e.g. decoding margin. The decoding margin defines the share of the available resources that was required to successfully decode the packet. This could, e.g., be processing capacity in the wireless device, and in some embodiments can also be an indicator of how much of the transmitted signal needed to be used in order to successfully decode.

In principle, the decoding margin will reflect other blocks in the physical layer described above as well. However, the information indicative of a decoding margin may include other metrics as well reflecting the steps before the decoder. Different metrics may be used to define the decoding margin such as time, iterations, active blocks or units; or number of repetitions needed.

Hence, the ACK comprises information indicating the constraints of receiving wireless device associated with the successful decoding of the transport block. The constraint may e.g. be indicated as a part of a total capacity. Thus, according to some aspects, the decoding margin comprises an indication of a portion of the transmitted repetitions that was used for the reception and/or decoding of the packet.

According to some aspects, the decoding margin comprises an indication of a portion of the number of repeated transmissions that was needed in order to decode the packet.

The indication can be constructed in several ways:
A separate indicator can be designed. That is, instead of sending only an ACK, the wireless device 10 can send “ACK already after repetition k”. In other words, the ACK includes a field indicating how much information was needed to decode the packet.
The wireless device 10 can send a single ACK as soon as it has managed to decode the packet. Based on when the ACK is received, the radio network node 20 knows how large the decoding margin was.
The wireless device 10 can send an ACK/NACK after each repeated transmission. Based on where the ACK is received, the radio network node 20 knows how large the decoding margin was.

The wireless device 10 can be configured to send ACK/NACK referring to one or more transmissions. For example, if having four repetitions, the wireless device 10 can be configured to report ACK/NACK after transmission 3 and 4; i.e., also before the final transmission. Then ACK after 3^{rd} transmission can be regarded as a hard ACK, and ACK after 4^{th} transmission can be regarded as a soft ACK. Configuration of when to send ACK/NACK can be configured to be repetition number from the beginning, but also on repetition number from the end, e.g., to always report ACK/NACK at the second to last repetition.
Also, by making it configurable what the ACK/NACK refers to will make it possible for the eNB to monitor reliability without having a block error. If, for example, the wireless device 10 (e.g. a UE) would report the ACK/NACK related to the second last repetition, an ACK would be a strong ACK that it was possible to decode without using all repetitions. A NACK, however, would mean that the wireless device 10 was not able to decode it without using all repetitions, but possibly using the last repetition. This would indicate to the radio network node 20 (e.g. an eNb) that the margin is too small, and the radio network node 20 may then choose a more robust format, e.g. increase number of repetitions or lower the MCS. Hence, by setting the UE report ACK/NACK related to an earlier transmission than the last transmission, the eNb could monitor and adjust link reliability, without having a block error. As an example, this be done by configuring over e.g. radio resource control (RRC) signaling which repetition (such as on a Physical Downlink Shared Channel (PDSCH)) the ACK/NACK should refer to: either ACK/NACK related to last repetition, or ACK/NACK related to second last repetition. FIG. 10a illustrates when the ACK/NAK is given by the last repetition (TX4) and sent at the timing given by the last repetition. FIG. 10b illustrates when the ACK/NACK is given by second last repetition (TX3), delayed and sent at timing given by the last repetition.

Example of ACK with Decoding Margin Related to Repetitions

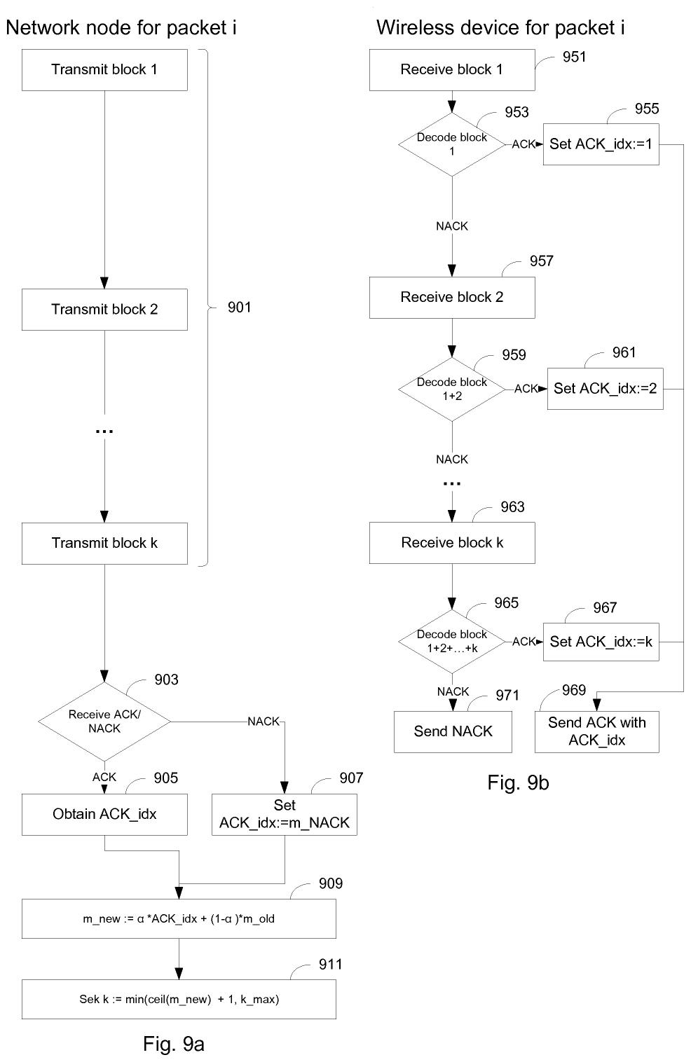

FIGS. 9a and 9b are flowcharts depicting an example of operations by a network node (FIG. 9a) and wireless device node (FIG. 9b) when the decoding margin is transmitted as a separate indicator indicating after which transmitted block the wireless device managed to decode the packet. This is just one example; many other combinations are possible. For example, the network node can choose to change not only the repetition factor k, but also other properties such as for example MCS.

Network Node Operation of Transmission of Packet i:

The network node is configured to transmit k repetitions of a transport block related to each packet. The network node transmits the k repetitions (901). The network node then receives an ACK or NACK from the wireless device (903).

If an ACK is received, an ACK_idx is also received (905), indicating how early the wireless device managed to decode the packet. If a NACK is received, the ACK_idx may be assigned to a constant m_NACK (907), which typically is larger than the maximum number of repetitions, k_max.

The ACK_idx may then be filtered over time (909). In this example, a first order AR filter is used, weighting in the new ACK_idx value with the factor α and remembering an old value with a factor (1−α).

A new value of number of repetitions, k, may now be calculated (911). In this example, this is done by rounding m_new value upwards, and adding an extra repetition as an extra margin.

Finally, the number of repetitions may be limited to a maximum number of iterations, k_max.

Wireless Operation of Transmission of Packet i:

The wireless device receives transmission 1 (951). It then tries to decode (953). If successful, it sets the ACK_idx to 1 (955).

If transmission 1 fails, then it receives transmission 2 (957) and tries to decode the soft combination of transmission 1 and 2 (959). If successful, set ACK_idx to 2 (961).

This is repeated up to transmission k (963). It tries to decode the soft combination of transmissions 1,2, . . . ,k (965) and if this succeeds, then it sets ACK_idx to k (967).

If any of the above decodings were successful, transmit an ACK with ACK_idx (969). Otherwise, transmit a NACK (971).

The ACK with a certain ACK_idx serves as a decoding margin. The lower the ACK_idx, the higher the decoding margin.

According to some aspects, the receiving S2 implies receiving information defining one of several possible ACK levels, wherein each level corresponds to a decoding margin within a pre-defined range. Stated differently, the decoding margin is an indication on whether decreasing the robustness of the transmission S1, would cause a severe risk in unsuccessful decoding. This aspect implies that one or more ACK levels are introduced; wherein each ACK level represents a decoding margin, i.e. how much of its capacity or how much effort the receiver and/or decoder had to use in order to successfully decode the block. For example Soft ACK and Hard ACK, where Soft ACK indicates that the UE successfully decoded the block but just barely so. Hard ACK indicates that the block was successfully decoded with good margin. By receiving Soft ACK the base station is informed that there is a risk due to channel variations that a subsequent package will fail. However, Hard ACK indicates that there may be unnecessary overhead in the transmission. The UE may decide whether to send Soft ACK or Hard ACK for a successfully decoded block based on how much of the received signal it had to use in the decoding.

According to some aspects, the method further comprises reconfiguring S3 the transmission properties to be used for transmissions of one or more further transport block sequences to the receiving wireless device 10, based on the decoding margin. In other words, the radio network node may utilize the decoding margin in order to maximize utilization of network resources.

According to some aspects, the reconfiguring S3 comprises changing the robustness of transmissions of one or more further transport block sequences to the receiving wireless device 10, in relation to robustness of the transmission of the transport block sequence. The robustness is the risk of block errors and is typically dependent on resource use.

According to some aspects, the reconfiguring S3 comprises selecting transmission properties corresponding to a robustness which is higher than the robustness of the transmission of the transport block sequence, if the decoding margin is below a predefined level. According to some aspects, reconfiguring S3 comprises selecting transmission properties corresponding to a robustness which is lower than the robustness of the transmission of the transport block sequence, if the decoding margin is above a predefined level. In other words, if the information indicative of a decoding margin is high, the network node may choose to select a less robust transmission in any way. Such a predefined level may be predefined or dynamically adjusted based on the current circumstances or services used. For C-MTC a specific level may be used.

Hence, robustness is typically increased by adding resources or decreased by reducing resources. Resources are e.g. physical resources or radio resources (time and/or frequency).

According to some aspects, robustness is adjusted by transmitting on the downlink using transmit diversity instead of using spatial diversity even should the UE have reported channel conditions (rank via RI) that would allow spatial diversity to be used (MIMO).

According to some aspects, robustness can be adjusted by combining means other than just MCS alone. For instance, downlink transmissions may use different power offsets between data and reference symbols for the UE allocation, or may apply ICIC/eICIC to improve the reception of a UE at the cell border.

Robustness may also be adjusted by transmitting on the downlink using transmit diversity instead of using spatial diversity even if the UE had reported channel conditions (rank via RI) that would allow spatial diversity to be used (MIMO).

Robustness may be adjusted by changing other parameters than MCS alone. For instance, downlink transmissions may use different power offsets between data and reference symbols for the UE allocation, or may apply ICIC/eICIC to improve the reception of a UE at the cell border.

Robustness may also be adjusted by transmitting on the downlink using transmit diversity instead of using spatial diversity even should the UE have reported channel conditions (rank via RI) that would allow spatial diversity to be used (MIMO).

Robustness may be adjusted by adjusting the number of repetitions of a transmitted message. If more repetitions are transmitted, the robustness increases, at the cost of lowered spectral efficiency.

Typically, the robustness is not changed directly, but based on an average decoding margin e.g. ratio between SACK and HACK. This ratio in turn controls whether the robustness level is to be changed. This is similar to existing outer loop link adaptation, where MCS offset is adjusted to have a BLER of e.g. 10%.

Hence, according to some aspects, the method further comprises calculating an accumulated decoding margin, representing the decoding margin of previous and present transport block sequences transmitted, using the set of transmission properties, between the radio network node 20 and the wireless device 10. Then the reconfiguring S4 is based on the accumulated decoding margin.

According to some aspects, the method further comprises transmitting S4, using the reconfigured transmission properties, one or more further transport block sequences to the receiving wireless device 10.

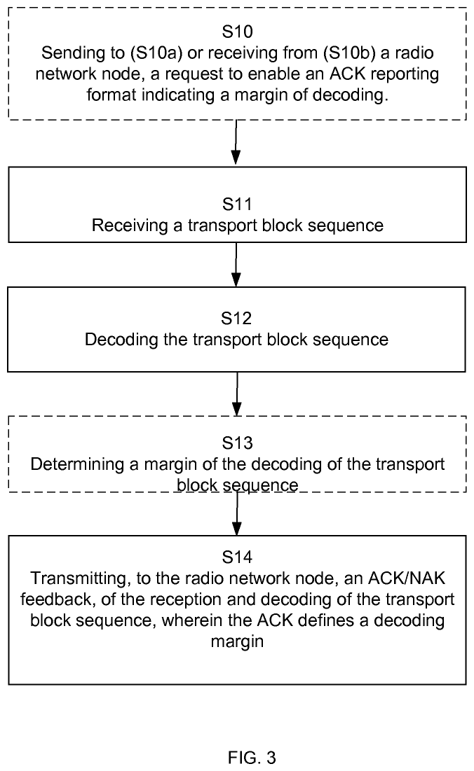

A corresponding method, performed in a wireless device 10, of providing transmission feedback, to a radio network node 20 will now be described with reference to FIG. 3. Hence the following method steps may be implemented in a device when receiving a transport block sequence.

As described above, the extended ACK format may be enabled through some signaling between the network node and the wireless device. According to some aspects, the method further comprises sending S10a request to enable an ACK reporting format indicating a decoding margin, to the radio network node 20. According to some aspects, the method further comprises receiving S10b a request to enable an ACK reporting format indicating a decoding margin from a radio network node 20.

It should be appreciated that FIG. 3 comprises some operations which are illustrated with a solid border and some operations which are illustrated with a dashed border. The operations which are comprised in a solid border are operations which are comprised in the broader example embodiment. The operations which are comprised in a dashed border are example embodiments which may be comprised in, or a part of, or are further operations which may be taken in addition to the operations of the broader example embodiments. It should be appreciated that the operations need not be performed in order. Furthermore, it should be appreciated that not all of the operations need to be performed. The example operations may be performed in any suitable order and in any combination.

The proposed method of providing feedback comprises receiving S11 a transport block sequence from the radio network node 20 and decoding S12 the transport block sequence. In other words this step implies that the transport block sequence transmitted in step S1 is received in the wireless device. When decoding the block sequence, a decoding margin is determined, step S13. The decoding margin may e.g. be determined by reading values or data from the decoder or from a memory.

The method then comprises transmitting S14, to the radio network node 20, an acknowledgement, ACK, of the reception and successful decoding of the transport block sequence, wherein the ACK defines a decoding margin of the decoding. According to some aspects, the ACK defines one of several possible ACK levels, wherein each ACK level corresponds to a decoding margin within a pre-defined range.

According to some aspects, the decoding margin comprises an indication of how many of the number of repeated transmissions were needed in order to decode the packet.

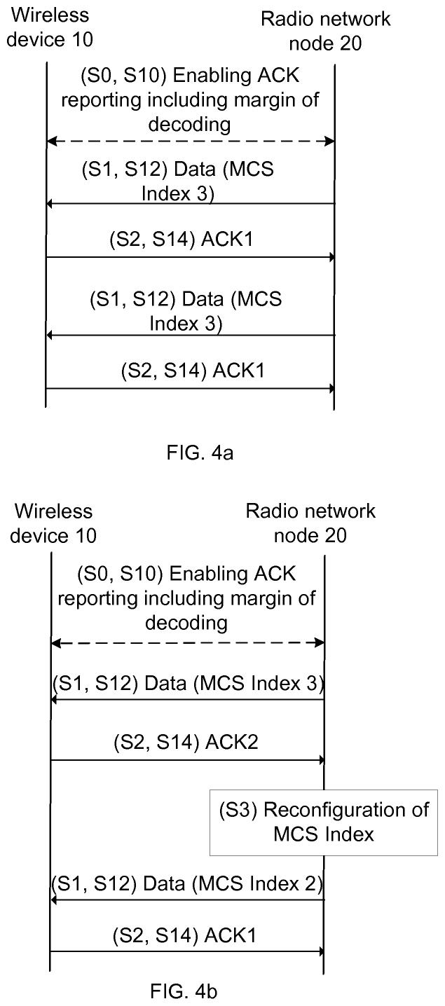

FIGS. 4a and 4b are signaling diagrams illustrating the signaling between a radio network node and a wireless device.

In FIG. 4a the radio network node is transmitting using Modulation and Coding Scheme with index 3. In this example the wireless device responds with a Soft ACK, here called ACK1. This indicates that the decoding margin is below a threshold. In this example the radio network node therefore does not change its transmission properties.

In FIG. 4b the radio network node is also transmitting using Modulation and Coding Scheme with index 3. However, in the example of FIG. 1b the wireless device responds with a Hard ACK, here called ACK2. This indicates that the decoding margin is above a threshold. In this example the radio network node therefore does changes its transmission properties to use a less robust modulation scheme in order to free up resources. This can be done with a low risk of losing packets because it is known that the decoding margin is low. Note that this is a simplified example. A more likely implementation would be to accumulate ACKs over time and change the MCS when the rate of HACK is above a level.

Example Node Configuration of a Radio Network Node

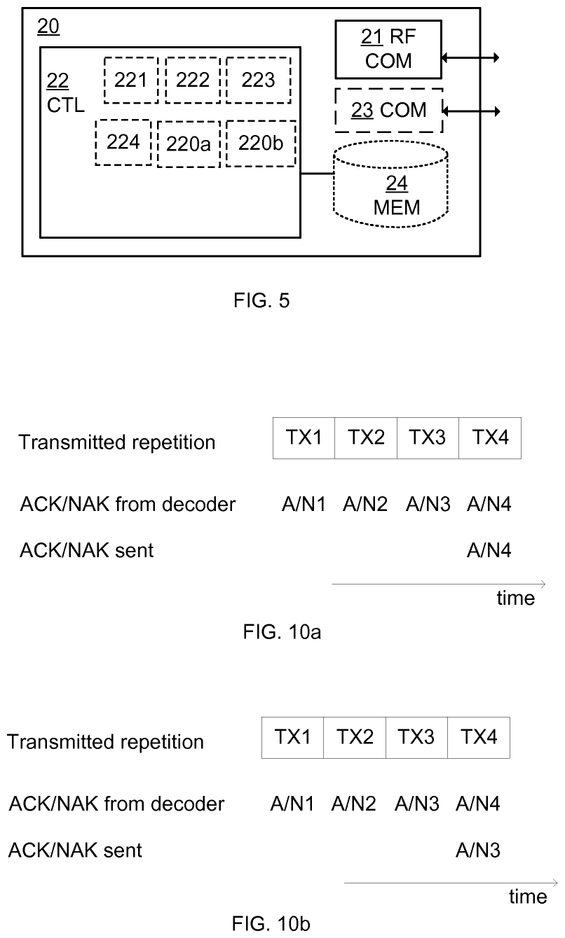

FIG. 5 illustrates an example of a radio network node 20 which may incorporate some of the example node operation embodiments discussed above. As shown in FIG. 5, the radio network node 20 may comprise a radio communication interface 21 configured to receive and transmit any form of communications or control signals within a network. It should be appreciated that the radio communication interface 21 may be comprised as any number of transceiving, receiving, and/or transmitting units or circuitry. It should further be appreciated that the radio communication interface 21 may be in the form of any input/output communications port known in the art. The radio communication interface 21 may comprise RF circuitry and baseband processing circuitry (not shown).

The radio network node 20 may comprise a network communication interface 23 configured to exchange any form of communications or control signals with a core network and/or with other network nodes. The network communication is typically referred to as a backhaul.

The radio network node 20 may further comprise at least one memory unit or circuitry 24 that may be in communication with the radio communication interface 21. The memory 24 may be configured to store received or transmitted data and/or executable program instructions. The memory 24 may also be configured to store any form of beam-forming information, reference signals, and/or feedback data or information. The memory 24 may be any suitable type of computer readable memory and may be of volatile and/or non-volatile type. According to some aspects, the disclosure relates to a computer program comprising computer program code which, when executed in a radio network node, causes the radio network node to execute any aspect of the example node operations described above.

The radio network node 20 may further comprise further a controller or processing circuitry 22 configured to transmit, through the radio communication interface 21 using a set of transmission properties, a transport block sequence to a receiving wireless device 10, to receive, through the radio communication interface 21, from the receiving wireless device 10, an acknowledgement, ACK, confirming the reception and successful decoding of the transport block sequence in the receiving wireless device 10, wherein the ACK defines a decoding margin of the decoding.

The processing circuitry 22 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry. The processing circuitry is further adapted to perform all the aspects of the method in a network node described above and below.

According to some aspects, the processing circuitry 22 is further configured to reconfigure the transmission properties to be used for transmissions of one or more further transport block sequences to the receiving wireless device 10, based on the decoding margin.

According to some aspects, the processing circuitry 22 is further configured to transmit, using the reconfigured transmission properties, one or more further transport block sequence sequences to the receiving wireless device 10.

According to some aspects, the processing circuitry 22 is further configured to reconfigure the transmission properties to be used for transmissions of one or more further transport block sequences to the receiving wireless device 10 by changing the robustness of transmissions of one or more further transport block sequences to the receiving wireless device 10, in relation to robustness of the transmission of the transport block sequence.

According to some aspects, the processing circuitry 22 is further configured to reconfigure the transmission properties to be used for transmissions of one or more further transport block sequences to the receiving wireless device 10 by selecting transmission properties corresponding to a robustness which is higher than the robustness of the transmission of the transport block sequence, if the decoding margin is below a predefined level.

According to some aspects, the processing circuitry 22 is further configured to reconfigure the transmission properties to be used for transmissions of one or more further transport block sequences to the receiving wireless device 10 by selecting transmission properties corresponding to a robustness which is lower than the robustness of the transmission of the transport block sequence, if the decoding margin is above a predefined level.

According to some aspects, the processing circuitry 22 is further configured to calculate S35 an accumulated decoding margin, representing the decoding margin of previous and present transport block sequences transmitted, using the set of transmission properties, between the radio network node 20 and the wireless device 10. Then the processing circuitry 22 is further configured to reconfigure the transmission properties to be used for transmissions of one or more further transport block sequences to the receiving wireless device 10 based on the accumulated decoding margin.

According to some aspects, the transmission properties comprise one or several of the following properties: Modulation and Coding Scheme, Radio Access Technology, Multiple Input Multiple Output transmission modes, Beam forming, Pre-coding Matrix and Transmission Power.

According to some aspects, the decoding margin comprises an indication of a portion of a processing capacity of the radio network node 20 that was used for the reception and/or decoding of the transport block sequence.

According to some aspects, the processing circuitry 22 is further configured to receive information defining one of several possible ACK levels, wherein each level corresponds to a decoding margin within a pre-defined range.

According to some aspects, the processing circuitry 22 is further configured to send a request to enable an ACK reporting format indicating a margin of decoding, to the receiving wireless device 10.

According to some aspects, the processing circuitry 22 is further configured to receive a request to enable an ACK reporting format indicating a margin of decoding from the receiving wireless device 10.

According to some aspects, processing circuitry 22 comprises a transmitter module 221 configured to transmit, through the radio communication interface 21 using a set of transmission properties, a transport block to a receiving wireless device 10. The processing circuitry further comprises a receiver module 222 configured to receive, through the radio communication interface 21, from the receiving wireless device 10, an acknowledgement, ACK, confirming the reception and successful decoding of the transport block sequence in the receiving wireless device 10, wherein the ACK defines a decoding margin of the decoding.

According to some aspects, the processing circuitry further comprises a sender module 220a configured to send a request to enable an ACK reporting format indicating a decoding margin, to the receiving wireless device 10.

According to some aspects, the processing circuitry further comprises a receiver module 220b configured to receive a request to enable an ACK reporting format indicating a decoding margin from the receiving wireless device 10.

According to some aspects, the processing circuitry further comprises a reconfiguration module 223 configured to reconfigure the transmission properties to be used for transmissions of one or more further transport block sequences to the receiving wireless device 10, based on the decoding margin.

According to some aspects, the processing circuitry further comprises a transmitter module 224 configured to transmit, using the reconfigured transmission properties, one or more further transport block sequences to the receiving wireless device 10.

Example Node Configuration of a Wireless Device

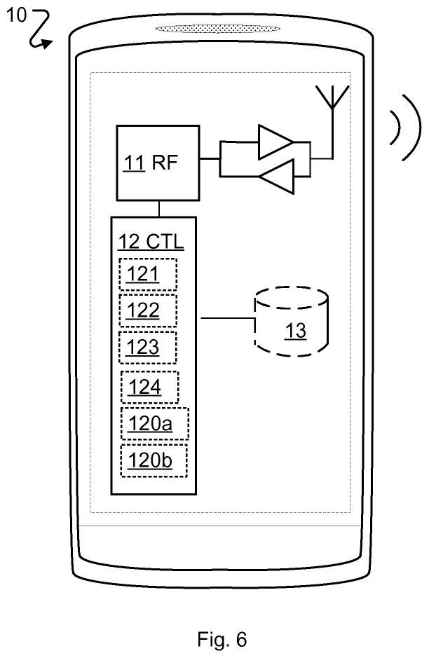

FIG. 6 illustrates an example of a receiving wireless device 10 which may incorporate some of the example node operation embodiments discussed above. As shown in FIG. 6, the wireless device 10 may comprise a radio communication interface 11 configured to receive and transmit any form of communications or control signals within a network. It should be appreciated that the radio communication interface 11 may be comprised as any number of transceiving, receiving, and/or transmitting units or circuitry. It should further be appreciated that the radio communication interface 11 may be in the form of any input/output communications port known in the art. The radio communication interface 11 may comprise RF circuitry and baseband processing circuitry (not shown).

The wireless device 10 may further comprise at least one memory unit or circuitry 13 that may be in communication with the radio communication interface 11. The memory 13 may be configured to store received or transmitted data and/or executable program instructions. The memory 13 may also be configured to store any form of beam-forming information, reference signals, and/or feedback data or information. The memory 13 may be any suitable type of computer readable memory and may be of volatile and/or non-volatile type. According to some aspects, the disclosure relates to a computer program comprising computer program code which, when executed in the wireless device, causes the wireless device to execute any aspect of the example node operations described above.

The wireless device 10 may further comprise a controller or processing circuitry 12 which may be configured to receive, through the radio communication interface 11, a transport block from the radio network node 20 and to decode the transport block. The processing circuitry 13 is further configured to transmit, through the radio communication interface 11, to the radio network node 20, an acknowledgement, ACK, confirming reception and successful decoding of the transport block sequence, wherein the ACK defines a decoding margin of the decoding.

The processing circuitry 12 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry. The processing circuitry is further adapted to perform all the aspects of the method in a wireless device described above and below.

According to some aspects, the ACK defines one of several possible ACK levels, wherein each ACK level corresponds to a decoding margin within a pre-defined range.

According to some aspects, the processing circuitry 12 is configured to send a request to enable an ACK reporting format indicating a margin of decoding, to the radio network node 20 or to receive a request to enable an ACK reporting format indicating a margin of decoding from a radio network node 20.

According to some aspects the processing circuitry comprises modules configured to perform the methods described above. Hence, according to some aspects, the processing circuitry 12 comprises a receiver module 121 configured to receive, through the radio communication interface 11, a transport block from the radio network node 20 and a decoder module 122 configured to decode the transport block. The processing circuitry 13 is further comprises a transmitter module 124 configured to transmit, through the radio communication interface 11, to the radio network node 20, an acknowledgement, ACK, of the reception and successful decoding of the transport block sequence, wherein the ACK defines a decoding margin of the decoding.

According to some aspects, the processing circuitry further comprises a sender module 120a configured to send to a wireless device, a request to enable an ACK reporting format indicating a margin of decoding.

According to some aspects, the processing circuitry further comprises a receiver module 120b configured to receive from a wireless device, a request to enable an ACK reporting format indicating a margin of decoding.

According to some aspects, the processing circuitry further comprises a determiner 123 configured to determine a decoding margin of the decoding of the first block.

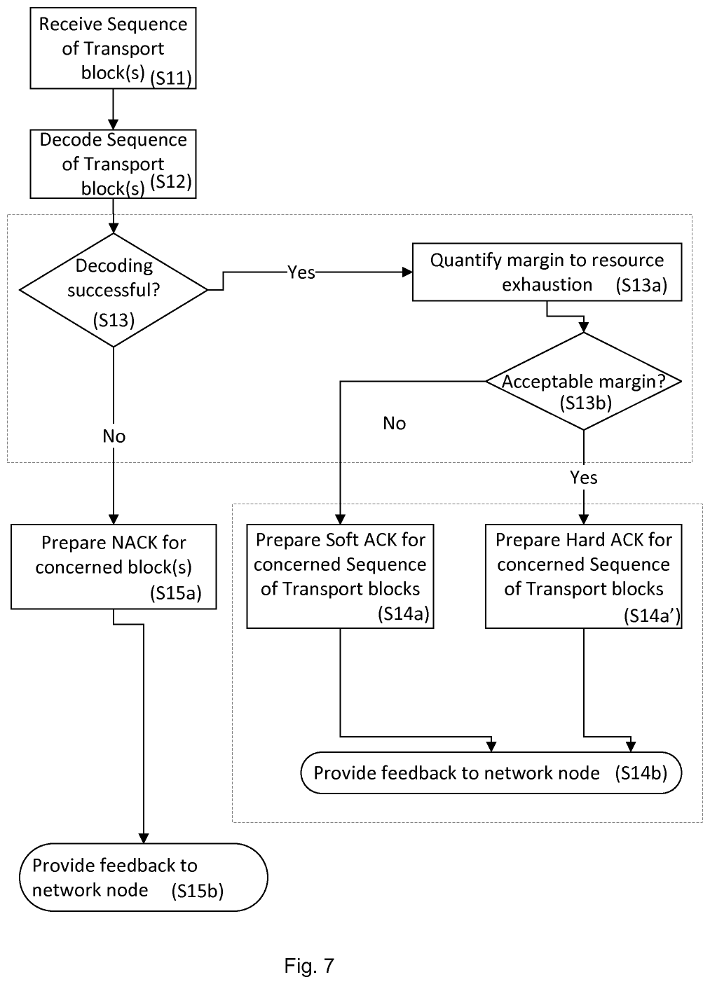

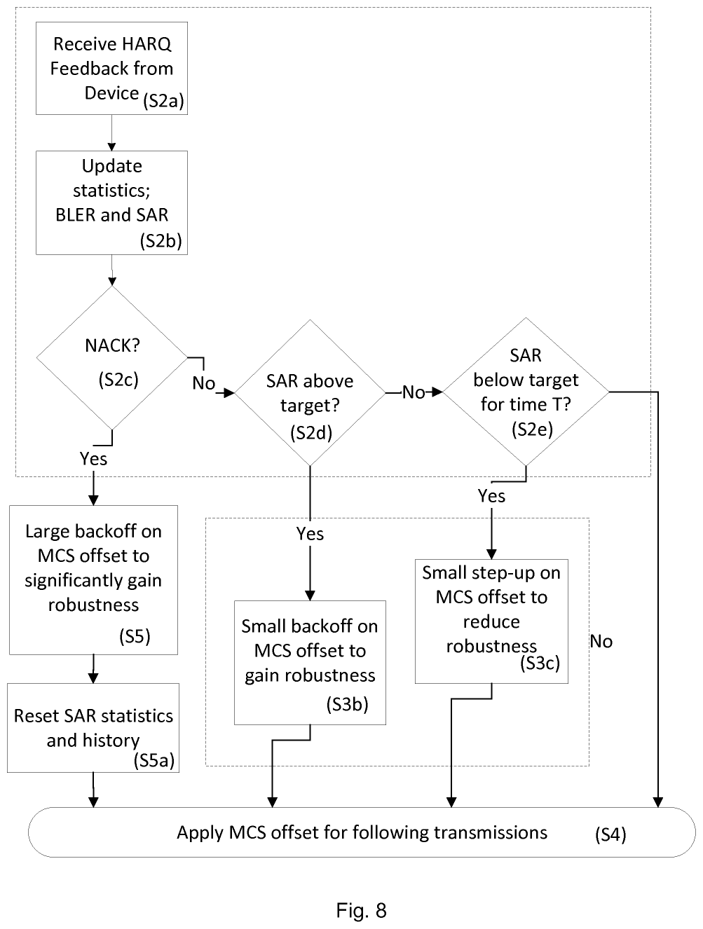

Two example implementations will now be described referring to FIGS. 7 and 8. Note that in FIGS. 7 and 8 letters a-d are used to show details of the method steps of FIGS. 3 and 4. For example steps S2a, S2b, S2c and S2d in FIG. 8 correspond to the more general step S2 in FIG. 3.

Example Implementation in UE

Example processing steps of the disclosure on UE side for downlink reception are shown in FIG. 7.

The UE receives S11 a sequence of transport blocks of data which it tries to decode S12. If the decoding fails S13; NO, the UE prepares a NACK S15a and sends it to the base station S15b. If on the other hand the decoding is successful S13; YES, the UE quantifies which margins it had in the decoding S13a. The margin can be related to how many of the repetitions the UE needed in order to decode the packet. For example, if decoding was successful before the last transport block S13b; YES, a Hard ACK is prepared S14a′ and sent S14b. But if all transport blocks were needed, S13b; NO, a Soft ACK is prepared S14a and sent S14b.

Example Implementation in a Network Node

Example processing steps of the disclosure on base station side for downlink transmission are shown in FIG. 8.

The base station receives a HARQ indicator from the UE S2a, and updates S2b the statistics and history for BLER and SAR S2b. History may here for instance be a buffer containing the N most recent NACKs and ACKs (Soft or Hard the same) for BLER, and Soft ACKs and Hard ACKs for SAR. The buffered data is used for calculating the BLER and SAR, respectively.

In case a NACK is received S2c; YES, the base station immediately adjusts the MCS offset for the UE to a safe setting providing considerably more robust transmission S5. It also resets the SAR statistics and clears the buffer used when calculating the SAR S5a. In the following transmissions it applies the new MCS offset when determining which MCS to use for a particular CQI index reported by the UE. The modification may for instance corresponding to increasing the robustness to two or more levels higher than used when the transport block was sent to the UE.

If a Hard or Soft ACK was received S2c; NO, the base station checks whether SAR is above the target SAR (e.g. SAR 10%), and if so S2d; YES it modifies the MCS offset to achieve for instance the next higher level of robustness than used when the transport block was sent to the UE, and uses that MCS offset when determining the MCS for following transmissions S3b. If the SAR is on or below target SAR S2d; NO, the base station checks how long time the SAR consistently has been below target. If this time exceeds some time T which may represent actual time, or TTIs for which Soft or Hard ACK have been received S2e; YES, the transmissions have been more robust than intended for some time, and the base station reduces the MCS offset to for instance to the next lower robustness level than used when the transport block was transmitted to the UE S3c. The parameter value of T may be configured e.g. from 0 (instantaneous) and upwards, allowing tuning of how inert the system is regarding reduction of robustness. It then applies the new MCS offset when determining the MCS to be used for following transmissions S4.

If the SAR has not been below target long enough S2e; NO, the base station uses the same MCS offset as used in previous transmission.

In case the UE does not send ACK/NACK when expected the base station may count this as a NACK.

Within the context of this disclosure, the terms “wireless terminal” or “wireless device” encompass any terminal which is able to communicate wirelessly with another device, as well as, optionally, with an access node of a wireless network by transmitting and/or receiving wireless signals. Thus, the term “wireless terminal” encompasses, but is not limited to: a user equipment, e.g. an LTE UE, a mobile terminal, a stationary or mobile wireless device for machine-to-machine communication, an integrated or embedded wireless card, an externally plugged in wireless card, a dongle etc. Throughout this disclosure, the term “user equipment” is sometimes used to exemplify various embodiments. However, this should not be construed as limiting, as the concepts illustrated herein are equally applicable to other wireless devices. Hence, whenever a “user equipment” or “UE” is referred to in this disclosure, this should be understood as encompassing any wireless terminal as defined above.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed example aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the embodiments, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed example embodiments. However, many variations and modifications can be made to these embodiments. Accordingly, although specific terms are employed, they are used in a generic and descriptive sense only and not for purposes of limitation.

1: A method, performed in a radio network node, of receiving transmission feedback, the method comprising:
transmitting, using a set of transmission properties, a first sequence of two or more transport blocks to a receiving wireless device, wherein the transmitting is performed without waiting for acknowledgement or non-acknowledgement (ACK/NACK) feedback in-between transport block transmissions, and wherein each of the transport blocks in the first sequence relates to a same packet; and
receiving, from the receiving wireless device, the ACK/NACK feedback, indicating reception and decoding outcome of the transport block sequence in the receiving wireless device, wherein the ACK/NACK feedback defines a decoding margin of the decoding.

2: The method of claim 1, comprising the step of:
reconfiguring the transmission properties to be used for transmissions of one or more further transport block sequences to the receiving wireless device, based on the decoding margin.

3: The method of claim 1, comprising the step of:
transmitting, using the reconfigured transmission properties, one or more further transport block sequences to the receiving wireless device.

4: The method of claim 1 wherein the reconfiguring comprises changing the robustness of transmissions of one or more further transport block sequences to the receiving wireless device, in relation to robustness of the transmission of the first sequence of transport blocks.

5: The method of claim 1, wherein reconfiguring comprises selecting transmission properties corresponding to a robustness which is higher than the robustness of the transmission of the first sequence of transport blocks, if the decoding margin defined by the ACK/NACK feedback is below a predefined level.

6: The method of claim 1, wherein reconfiguring implies selecting transmission properties corresponding to a robustness which is lower than the robustness of the transmission of the first sequence of transport blocks, if the decoding margin is above a predefined level.

7: The method of claim 1, comprising:
calculating an accumulated decoding margin, representing the decoding margin of previous and present sequences of transport blocks transmitted, using the set of transmission properties, between the radio network node and the wireless device;
wherein the reconfiguring is based on the accumulated decoding margin.

8: The method of claim 1, wherein the transmission properties comprises one or several of the following properties: Modulation and Coding Scheme, Radio Access Technology, Multiple Input Multiple Output transmission modes, Beam forming, Pre-coding Matrix, Transmission Power, and number of automatic repetitions.

9: The method of claim 1, wherein the decoding margin comprises an indication of a portion of the number of repetitions in the first transport block sequence that was used for the reception and/or decoding of the packet.

10: The method of claim 1, wherein the receiving comprises receiving information defining one of several possible ACK levels, wherein each level corresponds to a decoding margin within a pre-defined range.

11: The method of claim 1, comprising the step of:
sending a request to enable an ACK reporting format indicating a decoding margin, to the receiving wireless device.

12: The method of claim 1, comprising the step of:
sending a configuration to the wireless device that controls at what point in transport block reception ACK/NACK feedback reporting will occur.

13: The method of claim 1, comprising the step of:
receiving a request to enable an ACK reporting format indicating a decoding margin from the receiving wireless device.

14: A computer program comprising computer program code which, when executed in a programmable processing circuitry of a radio network node, causes the radio network node to execute a method, performed in a radio network node, of receiving transmission feedback, the method comprising:
transmitting, using a set of transmission properties, a first sequence of two or more transport blocks to a receiving wireless device, wherein the transmitting is performed without waiting for acknowledgement or non-acknowledgement (ACK/NACK) feedback in-between transport block transmissions, and wherein each of the transport blocks in the first sequence relates to a same packet; and
receiving, from the receiving wireless device, the ACK/NACK feedback, indicating reception and decoding outcome of the transport block sequence in the receiving wireless device, wherein the ACK/NACK feedback defines a decoding margin of the decoding.

15: A radio network node configured for receiving transmission feedback, the radio network node comprising a radio communication interface and processing circuitry, wherein the processing circuitry is configured:
to transmit, through the radio communication interface using a set of transmission properties, a first sequence of two or more transport blocks to a receiving wireless device, wherein the transmission is performed without waiting for acknowledgement or non-acknowledgement (ACK/NACK) feedback in-between transport block transmissions, and wherein each of the transport blocks in the first sequence relates to a same packet;
to receive, through the radio communication interface, from the receiving wireless device, the ACK/NACK feedback, indicating reception and decoding outcome of the first transport block sequence in the receiving wireless device, wherein the ACK/NACK feedback defines a decoding margin of the decoding.

16: The radio network node of claim 15, wherein the processing circuitry is further configured to reconfigure the transmission properties to be used for transmissions of one or more further transport block sequences to the receiving wireless device, based on the decoding margin.

17: The radio network node of claim 15, wherein the processing circuitry) is further configured to transmit, using the reconfigured transmission properties, one or more further transport block sequences to the receiving wireless device.

18: The radio network node of claim 15, wherein the processing circuitry is further configured to reconfigure the transmission properties to be used for transmissions of one or more further transport blocks to the receiving wireless device by changing the robustness of transmissions of one or more further transport block sequences to the receiving wireless device, in relation to robustness of the transmission of the transport block.

19: The radio network node of claim 15, wherein the processing circuitry is further configured to reconfigure the transmission properties to be used for transmissions of one or more further transport blocks to the receiving wireless device by selecting transmission properties corresponding to a robustness which is higher than the robustness of the transmission of the transport block, if the decoding margin defined by the ACK/NACK feedback is below a predefined level.

20: The radio network node of claim 15, wherein the processing circuitry is further configured to reconfigure the transmission properties to be used for transmissions of one or more further transport blocks to the receiving wireless device by selecting transmission properties corresponding to a robustness which is lower than the robustness of the transmission of the first sequence of transport blocks, if the decoding margin is above a predefined level.

21: The radio network node of claim 15, wherein the processing circuitry is further configured to calculate an accumulated decoding margin, representing the decoding margin of previous and present sequences of transport blocks transmitted, using the set of transmission properties, between the radio network node and the wireless device;
wherein the processing circuitry is further configured to reconfigure the transmission properties to be used for transmissions of one or more further sequences of transport blocks to the receiving wireless device based on the accumulated decoding margin.

22: The radio network node of claim 15, wherein the transmission properties comprises one or several of the following properties: Modulation and Coding Scheme, Radio Access Technology, Multiple Input Multiple Output transmission modes, Beam forming, Pre-coding Matrix, Transmission Power, and number of automatic repetitions.

23: The radio network node of claim 15, wherein the decoding margin comprises an indication of a portion of the number of repetitions in the first transport block sequence that was used for the reception and/or decoding of the packet.

24: The radio network node of claim 15, wherein the processing circuitry is further configured to receive information defining one of several possible ACK levels, wherein each level corresponds to a decoding margin within a pre-defined range.

25: The radio network node of claim 15, wherein the processing circuitry) is further configured to send a request to enable an ACK reporting format indicating the decoding margin, to the receiving wireless device.

26: The radio network node of claim 15, wherein the processing circuitry is further configured to send a configuration to the wireless device that controls at what point in transport block reception ACK/NACK feedback reporting will occur.

27: The radio network node of claim 15, wherein the processing circuitry is further configured to receive a request to enable an ACK reporting format indicating the decoding margin from the receiving wireless device.

28: A method, performed in a wireless device, of providing transmission feedback, wherein the method comprises:
receiving a sequence of transport blocks from the radio network node, wherein each of the transport blocks in the sequence relates to a same packet;
decoding one or more of the transport blocks; and
transmitting, to the radio network node, acknowledgement or non-acknowledgement (ACK/NACK) feedback indicating reception and decoding outcome of the transport block sequence, wherein the ACK/NACK feedback defines a decoding margin of the decoding, and wherein the decoding margin indicates how many of the transport blocks in the sequence were needed to successfully decode the packet.

29: The method of claim 28, wherein the ACK defines one of several possible ACK levels, wherein each ACK level corresponds to a decoding margin within a pre-defined range.

30: The method of claim 28, wherein an indicator in the ACK/NACK feedback indicates how many repetitions were needed for the decoding.

31: The method of claim 28, wherein the time position of the ACK/NACK transmission indicates number of transmissions needed for decoding.

32: The method of any of claim 28, wherein the transmitted ACK/NACK relates to decoding success at a configured location.

33: The method of claim 28, comprising:
sending a request to enable an ACK reporting format indicating the decoding margin, to the radio network node.

34: The method of claim 28, comprising:
receiving a request to enable an ACK reporting format indicating the decoding margin from a radio network node.

35: A computer program comprising computer program code which, when executed in a programmable processing circuitry of a wireless device, causes the wireless device to execute a method, performed in a wireless device, of providing transmission feedback, wherein the method comprises:
receiving a sequence of transport blocks from the radio network node, wherein each of the transport blocks in the sequence relates to a same packet;
decoding one or more of the transport blocks; and
transmitting, to the radio network node, acknowledgement or non-acknowledgement (ACK/NACK) feedback indicating reception and decoding outcome of the transport block sequence, wherein the ACK/NACK feedback defines a decoding margin of the decoding, and wherein the decoding margin indicates how many of the transport blocks in the sequence were needed to successfully decode the packet.

36: A wireless device configured for providing transmission feedback, the wireless device comprising a radio communication interface and processing circuitry, wherein the processing circuitry is configured:
to receive, through the radio communication interface, a sequence of transport blocks from the radio network node, wherein each of the transport blocks in the sequence relates to a same packet;
to decode one or more of the transport blocks; and
to transmit, through the radio communication interface, to the radio network node, acknowledgement or non-acknowledgement feedback indicating reception and decoding outcome of the transport block sequence, wherein the ACK/NACK feedback defines a decoding margin of the decoding, and wherein the decoding margin indicates how many of the transport blocks in the sequence were needed to successfully decode the packet.

37: The wireless device of claim 36, wherein the ACK defines one of several possible ACK levels, wherein each ACK level corresponds to a decoding margin within a pre-defined range.

38: The wireless device of any of claim 36, wherein an indicator in the ACK/NACK feedback indicates how many repetitions were needed for the decoding.

39: The wireless device of claim 36, wherein the time position of the ACK/NACK transmission indicates number of transmissions needed for decoding.

40: The wireless device of any of claim 36, wherein the transmitted ACK/NACK relates to decoding success at a configured location.

41: The wireless device of claim 36, wherein the processing circuitry is configured:
to send a request to enable an ACK reporting format indicating the decoding margin, to the radio network node.

42: The wireless device of claim 36, comprising:
to receive a request to enable an ACK reporting format indicating the decoding margin from a radio network node.
